(19) United States
(12) Patent Application Publication
(10) Pub. No.: US 2011/0240432 A1
(43) Pub. Date: Oct. 6, 2011

(54) HYDRAULIC POWER TRANSMISSION

(75) Inventors: Yoshihiro TAKIKAWA, Tsushimashi (JP); Hiroki NAGAI, Anjo-shi (JP); Kazuhiro ITOU, Anjo-shi (JP)

(73) Assignee: AISIN AW CO., LTD., Anjo-shi (JP)

(21) Appl. No.: 13/034,998

(22) Filed: Feb. 25, 2011

(30) Foreign Application Priority Data
Mar. 31, 2010 (JP) 2010-081057

(51) Int. Cl. F16H 45/02; F16F 7/10

(52) U.S. Cl. 192/3.29

(57) ABSTRACT

A hydraulic power transmission includes a pump impeller connected to an input member coupled to a prime mover, a turbine runner rotatable coaxially with the pump impeller, a damper mechanism having an input element, a resilient member engaged with the input element, an output element, and a lockup clutch capable of engaging the input member and the input element of the damper mechanism and releasing the engagement therebetween. The transmission also includes a dynamic damper configured in such a manner that oscillations transmitted to the input member when the input member and the input element of the damper mechanism are engaged by the lockup clutch are absorbed from the input element.

### INCORPORATION BY REFERENCE

The disclosure of Japanese Patent Application No. 2010-081057 filed on Mar. 31, 2010, including the specification, drawings and abstract thereof, is incorporated herein by reference in its entirety.

### BACKGROUND OF THE INVENTION

1. Field of the Invention

The present invention relates to a hydraulic power transmission including a pump impeller connected to an input member coupled to a prime mover, a turbine runner rotatable coaxially with the pump impeller, a damper mechanism having an input element, a resilient member engaged with the input element, and an output element, and a lockup clutch configured to be capable of engaging the input member and the input element of the damper mechanism and releasing the engagement therebetween.

2. Description of the Related Art

In the related art, a torque converter provided with a direct connection clutch having a damper mechanism including a driving plate, an outer damper spring, an intermediate plate, and a driven plate is known as the hydraulic power transmission of this type (for example, see JP-A-10-169756). In this torque converter, a turbine of a torque converter which does not contribute to torque transmission when the direct connection clutch is in the operating state is connected to a driven plate which is a member that contributes to the torque transmission via an inner damper spring as a resilient member, so that a dynamic damper is made up of the turbine of the torque converter and the inner damper spring.

Also, in the related art, a lockup device having a piston, an output plate, a first coil spring, an inertia member, and a second coil spring is also known (for example, see JP-A-2009-293671). In this lockup device, the output plate is coupled to the turbine so as to allow the output plate to rotate integrally with a turbine, so that the piston and the output plate are coupled by the first coil spring so as to be resilient in the direction of rotation. Also, the inertia member is provided so as to be relatively rotatable with the output plate, and the inertia member and the output plate is coupled by a second coil spring so as to be resilient in the direction of rotation. Accordingly, in this lockup device, the inertia member and the second coil spring constitute the dynamic damper.

### SUMMARY OF THE INVENTION

However, as the aforementioned hydraulic power transmission or the lockup device in the related art, even though the dynamic damper including a mass and a resilient member is coupled to the driven plate or the output plate as the output elements of the damper mechanism (a lockup damper mechanism), a sufficient oscillation damping effect cannot be obtained in many cases.

Accordingly, it is a principal object of a hydraulic power transmission according to the present invention to make oscillations transmitted to an input member effectively damped by a dynamic damper.

The hydraulic power transmission according to the present invention employs following unit for achieving the aforementioned principal object.

A hydraulic power transmission according to the present invention is a hydraulic power transmission having a pump impeller connected to an input member coupled to a prime mover, a turbine runner rotatable coaxially with the pump impeller, a damper mechanism having an input element, a resilient member engaged with the input element, and an output element, and a lockup clutch configured to be capable of engaging the input member and the input element of the damper mechanism and releasing the engagement therebetween, including:

a dynamic damper configured in such a manner that oscillations transmitted to the input member when the input member and the input element of the damper mechanism are engaged by the lockup clutch is absorbed from the input element.

The hydraulic power transmission includes the dynamic damper configured in such a manner that the oscillations transmitted to the input member when the input member and the input element of the damper mechanism are engaged by the lockup clutch is absorbed from the input element of the damper mechanism. Accordingly, in the hydraulic power transmission, the oscillations are absorbed by the dynamic damper on the more upstream side of a power transmitting route from the input member to an object of power transmission, so that the oscillations transmitted from the side of the prime mover to the hydraulic power transmission, that is, to the input member are absorbed (damped) effectively by the dynamic damper before being damped by the elements on the downstream side of the input element of the damper mechanism so that the probability of transmission of the oscillations to the downstream side of the input element can desirably be reduced. In the case that the input element of the damper mechanism includes a plurality of members, the dynamic damper may be configured so as to absorb the oscillations from any one of the plurality of members which constitute the input element. Then, the hydraulic power transmission may be configured in such a manner that the turbine runner is coupled to the object of power transmission from the prime mover, and that the output element of the damper mechanism is coupled to the object of power transmission.

Also, the output element of the damper mechanism may be coupled to an object of power transmission from the prime mover, and the dynamic damper may include at least the turbine runner and a second resilient member engaging both the turbine runner and the input element of the damper mechanism. Accordingly, the turbine runner which does not contribute to the power transmission in a range from the input member to the object of power transmission when the input member and the input element of the damper mechanism are engaged by the lockup clutch is used as a mass of the dynamic dumper, so that the oscillations transmitted from the prime mover side to the input member can be damped effectively by the dynamic damper.

Furthermore, the hydraulic power transmission may include a mass body added to the turbine runner. By adding the mass body to the turbine runner as described above, the oscillation damping characteristics of the dynamic damper including the turbine runner and the second resilient member can be set easily and flexibly.

Also, the hydraulic power transmission may further include a friction generating mechanism arranged between the input element of the damper mechanism and the turbine runner and configured to be capable of applying a friction according to the oscillations transmitted from the input element to the turbine runner to the input element when the input member and the input element of the damper mechanism are engaged by the lockup clutch and the number of revolutions of the input member is included in a predetermined revolution range in advance. In other words, if the oscillations transmitted to the input member is damped by the dynamic damper when the input member and the input element of the damper mechanism are engaged by the lockup clutch and the number of revolutions of the input member is included in a certain revolution range, the resonance may occur in the input member or in the input element of the damper mechanism when the number of revolutions of the input member is included in other ranges of number of revolutions. Therefore, in the hydraulic power transmission, the revolution range of the input member which causes the resonance in association with the utilization of the dynamic damper is set in advance, and a friction according to the oscillations transmitted from the input element of the damper mechanism to the turbine runner when the number of revolutions of the input member is included in the revolution range is applied from the friction generating mechanism to the input element. Accordingly, the resonance generated in association with the utilization of the dynamic damper can be desirably damped, so that the probability of transmission of the oscillation to the downstream side of the input element can be desirably reduced.

Furthermore, the friction generating mechanism may include an annular member arranged between the input element of the damper mechanism and the turbine runner so as to be pivotable about an axis and engaging the turbine runner with a play, and a friction member fixed to the annular member so as to come into contact with the input element. In this configuration, when the play between the turbine runner and the annular member is reduced by the oscillations of the turbine runner which is engaged with the input element via the second resilient member and hence the both come into abutment with each other, the annular member is moved with respect to the input element by the turbine runner and hence is fixed to the annular member, and the friction according to the oscillations can be applied from the friction member which comes into contact with the input element to the input element.

Also, the hydraulic power transmission may include a mass body added to the input element of the damper mechanism, and the weight of the mass body may be fixed so that the resonance frequency of a system including the input element, the mass body, and the resilient member engaging the input element matches the resonance frequency of the dynamic damper. Accordingly, by the dynamic damper, the oscillations transmitted from the side of prime mover to the hydraulic power transmission, that is, to the input member can be damped, and the occurrence of so-called the shudder while the lockup clutch slips can desirably be reduced.

Then, the hydraulic power transmission may include a stator which rectifies the flow of the hydraulic fluid from the turbine runner to the pump impeller, and the pump impeller, the turbine runner, and the stator may constitute the torque converter which has a torque amplification function. Also, the pump impeller and the turbine runner may constitute a fluid joint which does not have the torque amplification function.

### BRIEF DESCRIPTION OF THE DRAWINGS

FIG. 1 is a cross-sectional view showing a hydraulic power transmission 1 according to an embodiment of the present invention;

FIG. 2 is a cross-sectional view diagrammatically showing a principal portion of the hydraulic power transmission 1;

FIG. 3 is an enlarged view of a principal portion of the hydraulic power transmission 1;

FIG. 4 is an explanatory drawing for explaining an action of the hydraulic power transmission 1;

FIG. 5 is an explanatory drawing for explaining an action of the hydraulic power transmission 1; and

FIG. 6 is an explanatory drawing showing a relationship between the number of revolutions of an engine as a prime mover and an oscillation level of the hydraulic power transmission 1.

### DETAILED DESCRIPTION OF THE EMBODIMENTS

Subsequently, a mode for carrying out the present invention will be described using embodiments.

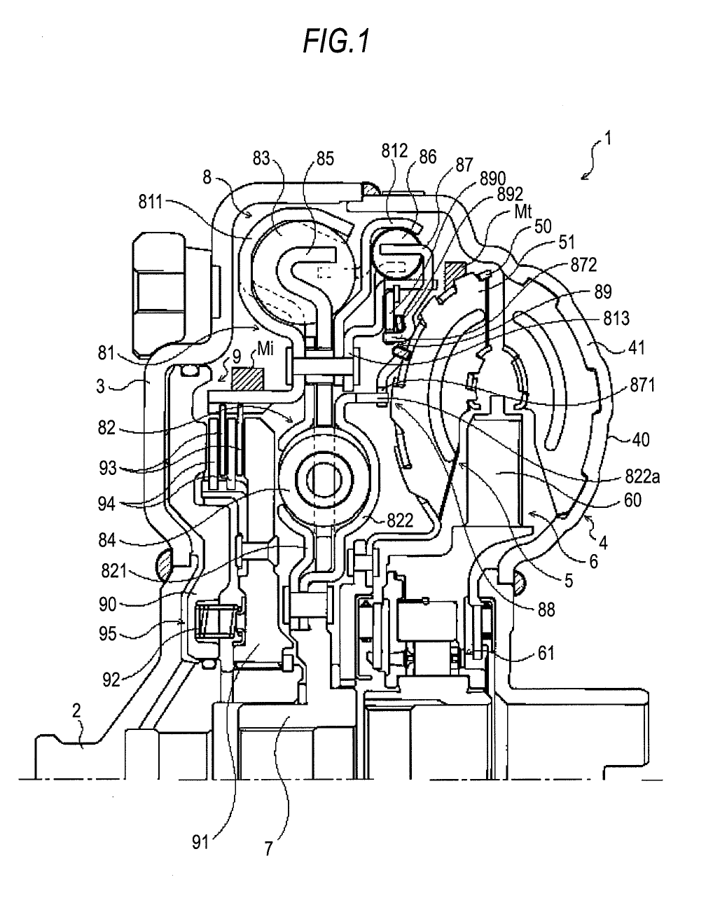

FIG. 1 is a cross-sectional view showing a hydraulic power transmission 1 according to an embodiment of the present invention. The hydraulic power transmission 1 shown in the drawing is a torque converter to be mounted on a vehicle having an engine as a prime mover as a starting device, and includes an input-side centerpiece (input member) 2 coupled to a crankshaft of an engine, not shown, a front cover 3 to be fixed to the input-side centerpiece 2, a pump impeller (input side hydraulic transmission element) 4 fixed to the front cover 3, a turbine runner (output side hydraulic transmission element) 5 rotatable coaxially with the pump impeller 4, a stator 6 configured to rectify the flow of hydraulic oil (hydraulic fluid) from the turbine runner 5 to the pump impeller 4, a damper hub (output member) 7 fixed to an input shaft of a variable speed gear as an automatic transmission (AT) or a continuously variable transmission (CVT), not shown, a damper mechanism 8 connected to the damper hub 7, and a lockup clutch 9 of a multiple disk frictional type which is capable of engaging (coupling) the input-side centerpiece 2 and the damper mechanism 8 and releasing the engagement (coupling) therebetween.

The pump impeller 4 includes a pump shell 40 fixed tightly to the front cover 3, and a plurality of pump blades 41 disposed on an inner surface of the pump shell 40. The turbine runner 5 includes a turbine shell 50 to be fixed to a turbine hub, and a plurality of turbine blades 51 disposed on an inner surface of the turbine shell 50, and the turbine shell 50 (turbine hub) is rotatably supported by the damper hub 7. The pump impeller 4 and the turbine runner 5 oppose to each other, and the stator 6 which is rotatable coaxially with the pump impeller 4 or the turbine runner 5 is arranged therebetween. The stator 6 includes a plurality of stator blades 60, and the direction of rotation of the stator 6 is set to one direction by a one-way clutch 61. The pump impeller 4, the turbine runner 5 and the stator 6 define a torus (annular flow channel) which allows circulation of the hydraulic oil.

The damper mechanism 8 includes an input element (driving element) 81 arranged in an area on the side of the outer periphery in an oil chamber defined by the front cover 3 and the pump shell 40 of the pump impeller 4 and configured to be capable of being integrated with the input-side centerpiece 2 in the direction of rotation by the lockup clutch 9, an output element (driven element) 82 arranged in an area on the side of the inner periphery in the oil chamber, fixed to the damper hub 7, and configured to support the input element 81 so as to be rotatable, and an annular intermediate element (intermediate plate) 85 engaged with the input element 81 via a plurality of first coil springs (resilient members) 83 and engaged with the output element 82 via a plurality of second coil springs 84.

The input element 81 includes an annular first input plate (driving plate) 811 arranged on the side of the front cover 3 (the engine side) and an annular second input plate (driving plate) 812 arranged on the side of the pump shell 40 (the variable speed gear side) as shown in FIG. 1. The first input plate 811 includes a plurality of spring accommodating portions configured to extend respectively in the circumferential direction and accommodating the first coil springs 83 on the outer peripheral side and a plurality of splines extending respectively in the axial direction on an inner peripheral portion thereof. Also, at one end of the each spring accommodating portion, there is formed an abutting portion which abuts one end of the corresponding first coil spring 83 (see a broken line in FIG. 1). The second input plate 812 is coupled (fixed) to the first input plate 811 via a plurality of rivets (see FIG. 1) and an outer peripheral portion of the intermediate element 85 is rotatably arranged about the axis between the first input plate 811 and the second input plate 812. Also, the second input plate 812 supports the first coil springs 83 accommodated in the respective spring accommodating portions of the first input plate 811 from inside.

The output element 82 includes an annular first output plate (driven plate) 821 arranged on the side of the front cover 3 (the engine side), and an annular second output plate 822 arranged on the side of the pump shell 40 (the variable speed gear side). The first output plate 821 includes a plurality of spring supporting portions extending respectively in the circumferential direction, and the second output plate 822 includes a plurality of spring supporting portions opposing the respective corresponding spring supporting portions of the first output plate 821. The respective second coil springs 84 are held by the spring supporting portions of the first output plate 821 and the spring supporting portions of the second output plate 822 corresponding thereto, and one end of the each second coil spring 84 comes into abutment with an abutting portion (not shown) formed on at least one of the first and second output plates 821 and 822. Then, arranged between the first output plate 821 and the second output plate 822 is an inner peripheral portion of the intermediate element 85 so as to rotate about the axis thereof, and the inner peripheral portions of the first and second output plates 821 and 822 are fixed to the damper hub 7 via the rivets. The intermediate element 85 includes a plurality of outer peripheral side engaging portions which come into abutment respectively with the other ends of the corresponding first coil springs 83 held by the first and second input plates 811 and 812, and a plurality of inner peripheral side engaging portions which come into abutment respectively with the other ends of the corresponding second coil springs 84 held by the first and second output plates 821 and 822.

The lockup clutch 9 is arranged inside the input element 81 and between the front cover 3 and the output element 82 as shown in FIG. 1. The lockup clutch 9 includes a lockup piston 90 supported by the input-side centerpiece 2 so as to be slidable in the axial direction, a clutch hub 91 opposed to the lockup piston 90 and supported by the input-side centerpiece 2 so as to be incapable of moving in the axial direction, a return spring 92 arranged between the lockup piston 90 and the clutch hub 91, a plurality of first clutch plates 93 supported axially slidably by the first input plate 811 of the input element 81 so as to be positioned between the lockup piston 90 and the clutch hub 91 via a plurality of splines, and a plurality of second clutch plates 94 supported axially slidably by the clutch hub 91 so as to be adjacent to the first clutch plates 93 between the lockup piston 90 and the clutch hub 91 via a plurality of splines.

The lockup piston 90 is arranged in the proximity to a radially extending portion of the input-side centerpiece 2 or the front cover 3, and a lockup chamber 95, which is connected to a hydraulic control unit, not shown, via a hydraulic oil supply hole formed on the input-side center piece 2 or an oil channel formed in an input shaft is defined between the back side of the lockup piston 90 and the input-side centerpiece 2 and the front cover 3. Accordingly, by supplying hydraulic oil (lockup pressure) into the lockup chamber 95 from the hydraulic control unit, not shown, via the hydraulic fluid supply hole or the like, the lockup piston 90 moves toward the clutch hub 91 and the first and second clutch plates 93 and 94 are held tightly between the lockup piston 90 and the clutch hub 91, so that the input-side centerpiece 2 is coupled to the damper hub 7 via the damper mechanism 8, whereby a power from the engine is transmitted to the input shaft of the variable speed gear via the input-side centerpiece 2, the damper mechanism 8 and the damper hub 7. By stopping the feeding of the hydraulic fluid into the lockup chamber 95, the hydraulic fluid in the lockup chamber 95 flows out to the oil channel in the input shaft from a hydraulic fluid discharging hole formed in the input-side centerpiece 2, whereby the lockup is released.

Here, the hydraulic power transmission 1 in the embodiment includes a plurality of third coil springs 86 (resilient members) arranged between the turbine runner 5 and the input element 81 (first element) from among a plurality of elements which constitute the damper mechanism 8 so as to come into abutment therewith respectively as shown in FIG. 1, and is configured in such a manner that when an excessive torque not smaller than a predetermined value, which exceeds a range of a torque (torque fluctuations) that an engine normally generates and exceeds an allowable input torque of the damper mechanism 8 is input from the engine as the prime mover into the input-side centerpiece 2 as the input member, the turbine runner 5 and the output element 82 (second element) other than the input element 81 (the first element) from among the plurality of elements which constitute the damper mechanism 8 rotate integrally. In other words, the input element 81 includes also a third input plate 813 arranged on the side of the pump shell 40 (the side of the variable speed gear) with respect to the second input plate 812 and coupled (fixed) to the first and second input plates 811 and 812 via the above-described rivets in addition to the above-described first input plate 811 and the second input plate 812. The third input plate 813 includes a plurality of spring supporting portions which extend respectively in the circumferential direction and support the third coil springs 86 and abutting portions (see a broken line in FIG. 1) each provided at one end of each of the spring supporting portions and configured to come into abutment with one end of each of the corresponding third coil springs 86, and holds the plurality of third coil springs 86 together with the second input plate 812. Also, fixed to the turbine shell 50 of the turbine runner 5 is an annular turbine coupling member 87 having a plurality of outer peripheral side engaging portions which respectively come into abutment with the other ends of the corresponding third coil springs 86 held between the second and third input plates 812 and 813. The turbine coupling member 87 is engageable with the second output plate 822 which constitutes the output element 82 via an engaging mechanism 88 on the inner peripheral side thereof.

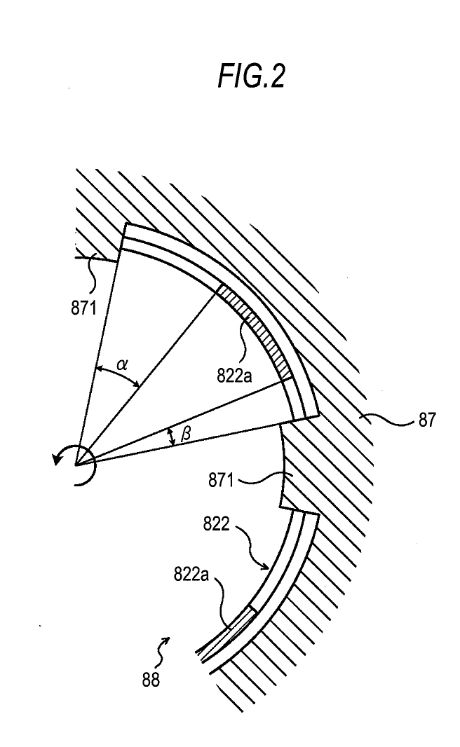

The engaging mechanism 88 includes a plurality of radial projections 871 disposed equidistantly on an inner peripheral portion of the turbine coupling member 87 and extending respectively radially inwardly, and a plurality of (the same number as the radial projections 871) of axial projections 822a disposed equidistantly on the outer peripheral portion of the second output plate 822 and extending respectively in the axial direction and toward the pump shell 40 side (the variable speed gear side) so as to be engageable with the radial projections 871 of the turbine coupling member 87 as shown in FIG. 2. The respective axial projections 822a of the second output plate 822 each have a circumferential length shorter than the distance between the adjacent radial projections 871 of the turbine coupling member 87 and, as shown in FIG. 2, positioned between the adjacent radial projections 871 of the turbine coupling member 87. Accordingly, the turbine coupling member 87 (the turbine runner 5) and the second output plate 822 (the output element 82) engage with each other with a play. In the embodiment, the numbers of the radial projections 871 and the axial projections 822a, the distance between the adjacent radial projections 871, and the distance between the adjacent axial projections 822a are determined in such a manner that when a torque which does not exceed the range of the torque (torque fluctuations) that the engine normally generates and not higher than the allowable input torque of the damper mechanism 8 is input from the engine as the prime mover to the input-side centerpiece 2 during the travel of the vehicle, as shown in FIG. 2, the respective radial projections 871 of the turbine coupling member 87 get slightly closer to the axial projections 822a on the upstream side in the direction of rotation without coming into abutment with any one of the axial projections 822a on the both side. In other words, when the excessive torque as described above is not input from the engine to the input-side centerpiece 2, the engaging mechanism 88 basically does not engage the turbine coupling member 87 (the turbine runner 5) and the second output plate 822 (the output element 82).

In contrast, when the revolving speed of the turbine coupling member 87 becomes larger than the revolving speed of the second output plate 822 by a large torque input to the turbine coupling member 87 via the input element 81 and the plurality of third coil springs 86 or via the pump impeller 4 and the turbine runner 5 in association with input of the excessive torque as described above from the engine as the prime mover into the input-side centerpiece 2, and hence the turbine coupling member 87 rotates with respect to the second output plate 822, the radial projections 871 of the turbine coupling member 87 come into abutment with the axial projections 822a on the downstream side in the direction of rotation, whereby the turbine coupling member 87 and the second output plate 822, that is, the output element 82 rotate integrally. In other words, the engaging mechanism 88 engages the turbine coupling member 87 (the turbine runner 5) and the second output plate 822 (the output element 82) when the excessive torque as described above is input from the engine to the input-side centerpiece 2. Incidentally, an angle α which defines the distance between the radial projections 871 and the axial projections 822a on the downstream side in the direction of rotation is fixed via an experiment and an analysis so as to achieve abutment between the radial projections 871 and the axial projections 822a on the downstream side in the direction of rotation at an adequate timing on the basis of a rigidity (spring constant) of the third coil springs 86 or the state of input of the torque to the input-side centerpiece 2, and an angle defining the distance between the radial projections 871 and the axial projections 822a on the upstream side in the direction of rotation is fixed via an experiment and an analysis so as to avoid the contact between the radial projections 871 and the axial projections 822a on the upstream side in the direction of rotation as much as possible due to the oscillations caused by a normal explosion of the engine.

Also, in the hydraulic power transmission 1 in the embodiment, a friction generating mechanism 89 is arranged between the input element 81 of the damper mechanism 8 and the turbine runner 5. The friction generating mechanism 89 is capable of applying a friction according to the oscillations transmitted from the input element 81 to the turbine runner 5 to the input element 81 when the input-side centerpiece 2 and the input element 81 of the damper mechanism 8 are engaged by the lockup clutch 9 and the number of revolutions of the engine as the prime mover, that is, the input-side centerpiece 2 is included in a predetermined resonant revolution range in advance.

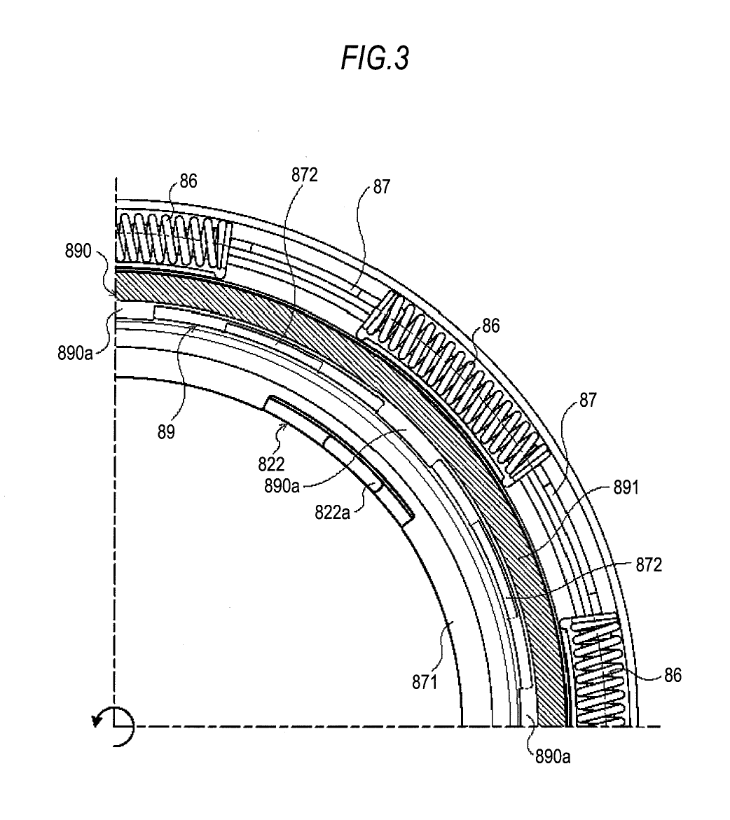

As shown in FIG. 1 and FIG. 3, the friction generating mechanism 89 in the embodiment includes an annular member 890 arranged between the third input plate 813 of the input element 81 and the turbine coupling member 87 fixed to the turbine runner 5 so as to be pivotable about the axis of the hydraulic power transmission 1. Bonded generally over the entire surface of the surface of the annular member 890 opposing the third input plate 813 (the surface on the left side in FIG. 1) is a friction member 891 as shown in FIG. 3. Then, the annular member 890 is arranged between the third input plate 813 and the turbine coupling member 87 so that the friction member 891 comes into contact with the third input plate 813, and is restricted from moving toward the turbine coupling member 87 (the right side in FIG. 1) by a snap ring fixed to the third input plate 813. Also, in the embodiment, an urging member 892 such as a conical spring or a wave washer is arranged between the back side of the annular member 890 and the turbine coupling member 87, and the annular member 890 is pressed against the third input plate 813 by the urging member 892. During the travel of the vehicle, the annular member 890 is pressed against the third input plate 813 by a thrust from the hydraulic fluid toward the front cover 3 (the engine side, that is, the left side in the drawing) generated in association with the rotation of the pump impeller 4, and hence the urging member 892 may be omitted.

In addition, the annular member 890 includes a plurality of radial projections 890a disposed equidistantly on an inner peripheral portion and each extending radially inwardly. Also, the turbine coupling member 87 fixed to the turbine runner 5 includes a plurality of (the same number as the radial projections 890a) axial projections 872 extending in the axial direction and toward the input-side centerpiece 2 side (the engine side) so as to be engageable with the radial projections 890a of the annular member 890. The respective axial projections 872 of the turbine coupling member 87 each have a circumferential length shorter than the distance between the adjacent radial projections 890a of the annular member 890 and, as shown in FIG. 3, positioned between the adjacent radial projections 890a of the annular member 890. Accordingly, the annular member 890 is engaged with the turbine coupling member 87 (the turbine runner 5) with a play.

In the embodiment, the numbers of the axial projections 872 and the radial projections 890a, the distance between the adjacent axial projections 872, and the distance between the adjacent radial projections 890a are fixed in such a manner that when the input-side centerpiece 2 and the input element 81 of the damper mechanism 8 are not engaged by the lockup clutch 9 or when the number of revolutions of the input-side centerpiece 2 is not included in the aforementioned resonant revolution range even thought the input-side centerpiece 2 and the input element 81 of the damper mechanism 8 are engaged by the lockup clutch 9, the annular member 890 and the input element (the third input plate 813) rotate integrally by a friction of the friction member 891 without bringing the respective axial projections 872 of the turbine coupling member 87 into abutment with any of the radial projections 890a on both sides during the travel of the vehicle. Also, in the embodiment, the number of the axial projections 872 and the radial projections 890a, the distance between the adjacent axial projections 872 and the distance between the adjacent radial projections 890a are fixed in such a manner that even though the frequency of oscillations of the turbine runner 5 engaging the input element 81 via the plurality of third coil springs 86 is minimum when the input-side centerpiece 2 and the input element 81 of the damper mechanism 8 engage with each other by the lockup clutch 9, and the number of revolutions of the engine as the prime mover, that is, of the input-side centerpiece 2 is included in the above-described resonant revolution range, the distance (play) between the axial projections 872 of the turbine coupling member 87 and the radial projections 890a of the annular member 890 is reduced and hence the both come into abutment with each other due to the oscillation of the turbine runner 5. Accordingly, when the input-side centerpiece 2 and the input element 81 of the damper mechanism 8 are engaged by the lockup clutch 9 and the number of revolutions of the engine as the prime mover, that is, of the input-side centerpiece 2 is included in the above-described resonant revolution range, the annular member 890 is moved (rotated) with respect to the third input plate 813 of the input element 81 by the turbine runner 5, whereby the friction according to the oscillations of the turbine runner 5 can be applied to the input element 81 from the friction member 891 which is fixed to the annular member 890 and comes into contact with the third input plate 813.

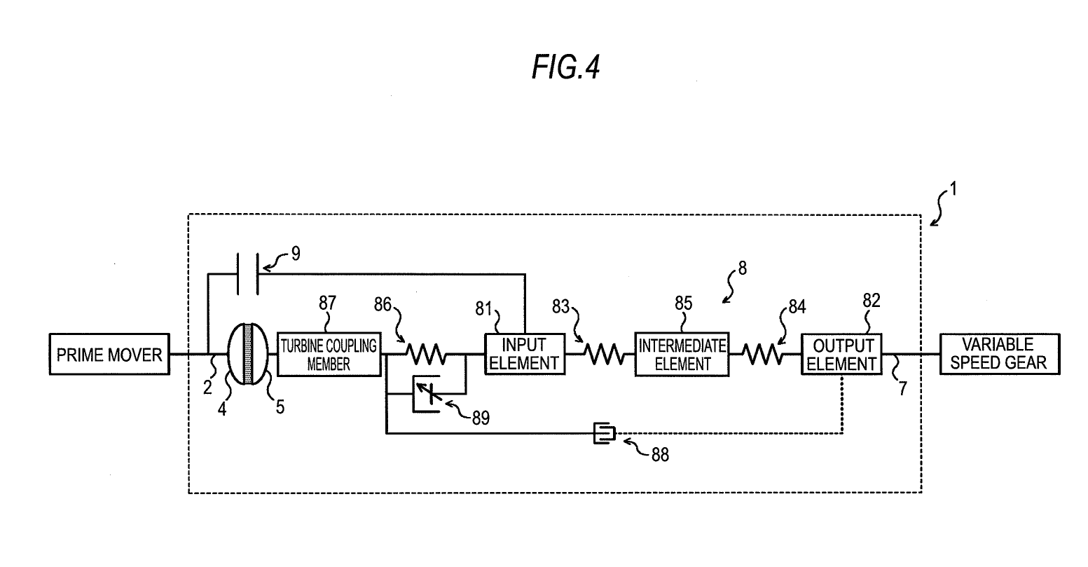

Referring next to FIG. 4 to FIG. 6, and so on, an action of the above-described hydraulic power transmission 1 will be described. In the hydraulic power transmission 1, when the lockup is OFF, that is, when the input-side centerpiece 2 and the input element 81 of the damper mechanism 8 are not engaged by the lockup clutch 9, a power from the engine as the prime mover is transmitted to an input shaft of the variable speed gear via a route from the input-side centerpiece 2, the pump impeller 4, the turbine runner 5, the turbine coupling member 87, the plurality of third coil springs 86, the input element 81, the plurality of first coil springs 83, the intermediate element 85, the plurality of second coil springs 84, the output element 82, and the damper hub 7 as shown in FIG. 4. At this time, fluctuations of the torque input to the input-side centerpiece 2 are absorbed mainly by the first and second coil springs 83 and 84 of the damper mechanism 8.

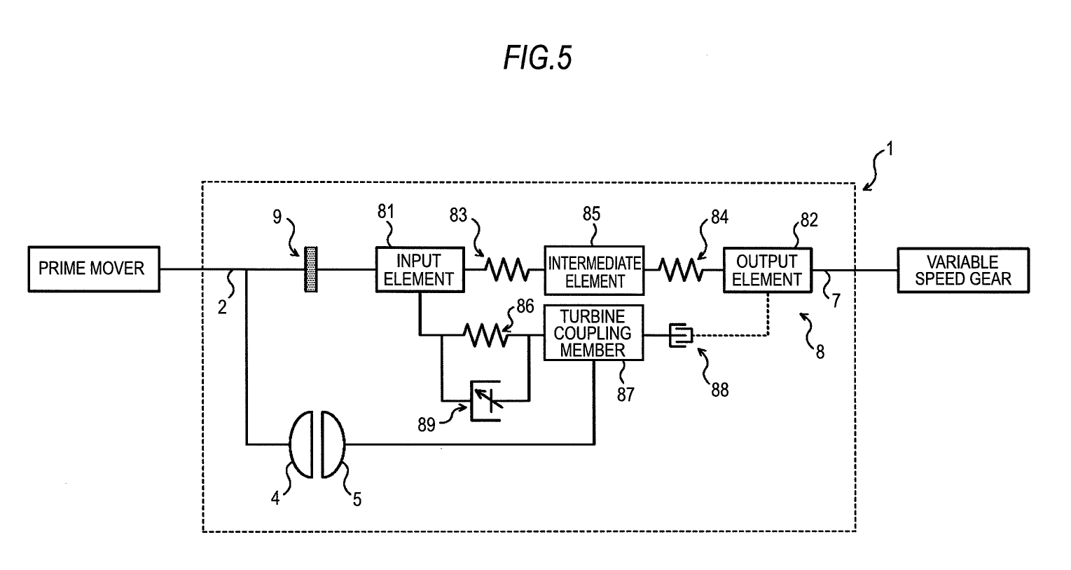

Also, when the lockup is ON, that is, when the input-side centerpiece 2 and the input element 81 of the damper mechanism 8 are engaged by the lockup clutch 9, a power from the engine as the prime mover is transmitted to an input shaft of the variable speed gear via a route from the input-side centerpiece 2, the lockup clutch 9, the input element 81, the plurality of first coil springs 83, the intermediate element 85, the plurality of second coil springs 84, the output element 82, and the damper hub 7 as shown in FIG. 5. At this time, fluctuations of the torque input to the input-side centerpiece 2 are absorbed mainly by the first and second coil springs 83 and 84 of the damper mechanism 8. In addition, in the hydraulic power transmission 1 in the embodiment, since the turbine runner 5, that is, the turbine coupling member 87 fixed to the turbine runner 5 is engaged with the input element 81 out of the plurality of elements which constitutes the damper mechanism 8 via the plurality of third coil springs 86, the plurality of third coil springs 86 as the resilient member constitute a dynamic damper together with the turbine runner 5 or the turbine coupling member 87 serving as masses which do not contribute to the torque transmission between the input-side centerpiece (input member) 2 and the damper hub (output member) 7 when the lockup is ON.

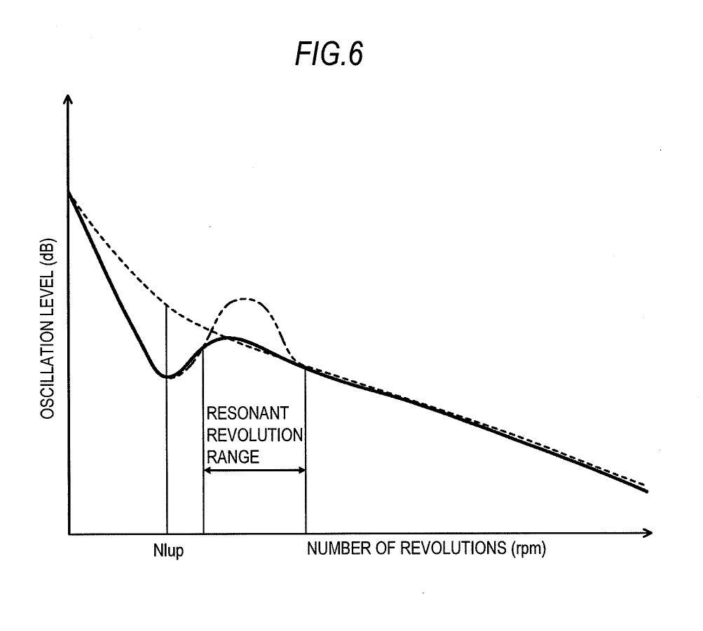

In other words, in the hydraulic power transmission 1 in the embodiment, the turbine coupling member 87 fixed to the turbine runner 5 is engaged with the input element 81 having a larger oscillating energy than the intermediate element 85 or the output element 82 when the lockup is ON and the revolving speed (the number of engine revolutions) of the input-side centerpiece 2 is relatively low from among the plurality of elements which constitute the damper mechanism 8 via the plurality of third coil springs 86 (resilient members), so that oscillations are absorbed by the dynamic damper which includes the plurality of third coil springs 86 and the turbine runner 5 and the turbine coupling member 87 as the masses on the upstream side of a power transmitting route from the input-side centerpiece 2 to the variable speed gear as the object of power transmission. Accordingly, when the lockup is ON, the oscillations transmitted from the engine side to the hydraulic power transmission 1, that is, to the input-side centerpiece 2 is absorbed (damped) effectively by the aforementioned dynamic damper before being damped by the elements on the downstream side of the input element 81 of the damper mechanism 8 so that the probability of transmission of the oscillations to the downstream side of the input element 81 can desirably be reduced. Therefore, in the hydraulic power transmission 1 in the embodiment, by adjusting the resonance frequency of the dynamic damper including the plurality of third coil springs 86 and the turbine runner 5 and the turbine coupling member 87 as the masses, that is, the rigidity (spring constant) of the third coil springs 86, weights (inertias) of the turbine runner 5 and the turbine coupling member 87 or the like on the basis of the number of cylinders of the engine as the prime mover and the number of engine revolutions when the lockup is executed, as shown by a solid line in FIG. 6, the oscillations transmitted from the engine as the prime mover to the hydraulic power transmission 1, that is, to the input-side centerpiece 2 when the number of engine revolutions is relatively low are effectively absorbed (damped) by the dynamic dumper and hence the probability of the transmission of the oscillations to the downstream side of the input element 81 can be desirably reduced in comparison with the case where the dynamic damper is coupled to, for example, the output element 82 of the damper mechanism 8 (see a broken line in FIG. 6).

Consequently, in the hydraulic power transmission 1 in the embodiment, the power transmitting efficiency can be improved and the oscillations which are liable to generate in the range from the input-side centerpiece 2 to the input element 81 when the revolving speed of the input-side centerpiece 2 (the number of engine revolutions) is relatively low at the time of, and after the engagement of the lockup clutch 9 can be desirably damped by executing the lockup in a state in which the number of engine revolutions reaches a relatively low lockup revolution Nlup on the order of 1000 rpm, for example. In this connection, in order to set the oscillation damping characteristics of the dynamic damper including the turbine runner 5 and the third coil springs 86 easily and flexibly and lowering the oscillation level near the lockup revolution Nlup as shown in FIG. 6, a weight Mt as a mass body can be added to the turbine runner 5 (or the turbine coupling member 87) as needed as shown in FIG. 1.

Incidentally, if the oscillations transmitted to the input-side centerpiece 2 when the input-side centerpiece 2 and the input element 81 of the damper mechanism 8 are engaged by the lockup clutch 9 and the number of revolutions of the input-side centerpiece 2 (the number of engine revolutions) is included in the low revolution range including the lockup revolution Nlup is damped to lower the oscillation level by the dynamic damper, as shown in FIG. 6, by the alternate long and two short dashes line, resonance may occur in the input-side centerpiece 2 or the input element 81 when the number of revolutions of the input-side centerpiece 2 (the number of engine revolutions) is increased thereafter. Therefore, the embodiment is configured in such a manner that the revolution range of the input-side centerpiece 2 (engine) which causes the resonance in association with the utilization of the dynamic damper is set in advance as the above-described resonant revolution range, and a friction according to the oscillations transmitted from the input element 81 to the turbine runner 5 via the third coil springs 86 and the turbine coupling member 87 when the number of revolutions of the input-side centerpiece 2 (engine) is included in the resonant revolution range is applied from the friction generating mechanism 89 to the input element 81. In other words, if the distance (play) between the axial projections 872 of the turbine coupling member 87 and the radial projections 890a of the annular member 890 is reduced and hence the both come into abutment with each other due to the oscillations of the turbine runner 5 which engages the input element 81 (the third input plate 813) via the third coil springs 86 and the turbine coupling member 87, the annular member 890 is moved (rotated) with respect to the input element 81 by the turbine runner 5, and thereby being fixed to the annular member 890 and applying the friction according to the oscillations to the input element 81 from the friction member 891 which comes into contact with the input element 81. Accordingly, as shown in FIG. 6, the resonance generated in association with the utilization of the dynamic damper can be desirably damped, so that the probability of transmission of the oscillation to the downstream side of the input element 81 can be desirably reduced.

Then, in the hydraulic power transmission 1, the plurality of third coil springs 86 between the turbine runner 5, that is, the turbine coupling member 87 fixed to the turbine runner 5 and the input element 81 as the first element serve as a damper which absorbs a torque on the basis of the excessive torque (the excessive torque by itself, or a large torque caused by the excessive torque) when the excessive torque as described above is input from the engine to the input-side centerpiece 2. In other words, in association with the input of the excessive torque from the engine to the input-side centerpiece 2 when the lockup is OFF, a large torque caused by the excessive torque is transmitted to the turbine runner 5, whereby the turbine coupling member 87 rotates with respect to the second output plate 822 and hence the radial projections 871 of the turbine coupling member 87 come into abutment with the axial projections 822a on the downstream side in the direction of rotation. Consequently, the turbine coupling member 87 and the second output plate 822, that is, the output element 82 rotate integrally with each other. Accordingly, the turbine coupling member 87 fixed to the turbine runner 5 is substantially coupled to the output element 82 of the damper mechanism 8 via the engaging mechanism 88 as indicated by a broken line in FIG. 3, and is substantially coupled to the output element 82 of the damper mechanism 8 via the plurality of third coil springs 86, the input element 81, the plurality of first coil springs 83, the intermediate element 85, and the plurality of second coil springs 84. Therefore, by enhancing the rigidity (spring constant) of the third coil springs 86 to a level higher than the rigidities (spring constants) of the first coil springs 83 and the second coil springs 84, when the lockup is OFF and the excessive torque is input from the engine to the input-side centerpiece 2, the third coil springs 86 can be functioned as the damper which absorbs the large torque caused by the aforementioned excessive torque.

Also, when the excessive torque is input to the input element 81 of the damper mechanism 8 in association with the input of the excessive torque as described above from the engine to the input-side centerpiece 2 when the lockup is ON, the turbine coupling member 87 which engages the input element 81 via the plurality of third coil springs 86 rotates with respect to the second output plate 822 and hence the radial projections 871 of the turbine coupling member 87 comes into abutment with the axial projections 822a on the downstream side in the direction of rotation. Consequently, the turbine coupling member 87 and the second output plate 822, that is, the output element 82 rotate integrally with each other. Accordingly, the input element 81 of the damper mechanism 8 is substantially coupled to the output element 82 via the plurality of first coil springs 83, the intermediate element 85, and the plurality of second coil springs 84, and is substantially coupled to the output element 82 via the plurality of third coil springs 86 and the turbine coupling member 87 as indicated by a broken line in FIG. 4. Therefore, by enhancing the rigidity (spring constant) of the third coil springs 86 to a level higher than the rigidities (spring constants) of the first coil springs 83 and the second coil springs 84, when the lockup is ON and the excessive torque is input from the engine to the input-side centerpiece 2, the third coil springs 86 can be functioned as the damper which absorbs the excessive torque.

The rigidity, that is, the spring constant of the third coil springs 86 which serve both as the dynamic damper and the excessive torque absorbing damper as described above is determined preferably by putting a priority on the torque absorbing characteristics on the basis of the excessive torque, and it is further preferable if the oscillation damping characteristics of the dynamic damper including the third coil springs 86, the turbine runner 5, and the turbine coupling member 87 are adjusted on the basis of the mass of the turbine coupling member 87 or the mass of the weight Mt attached to the turbine runner 5 or the turbine coupling member 87.

Furthermore, in the hydraulic power transmission 1 in the embodiment, it is possible to improve the power transmitting efficiency and the gas mileage of the engine by executing slip control which causes the lockup clutch 9 to slip during acceleration or during the deceleration. However, during the execution of the slip control as described above, or when the lockup clutch 9 slips during the engagement of the lockup clutch 9, so-called a shudder (oscillations) may occur. Therefore, in the hydraulic power transmission 1 in the embodiment, a weight Mi as the mass body is added to the input element 81 (the first input plate 811) of the damper mechanism 8 as shown in FIG. 1. Then, in the embodiment, the weight of the weight Mi is determined so that the resonance frequency of a system including the input element 81, the weight Mi, and the first coil springs 83 engaging the input element 81 matches the resonance frequency of a system including the aforementioned dynamic damper, that is, the turbine runner 5, the turbine coupling member 87, the weight Mt, and the third coil springs 86. Accordingly, the oscillations transmitted from the side of the engine as the prime mover to the input-side centerpiece 2 can be damped by the dynamic damper including the turbine runner 5 and the third coil springs 86, and the occurrence of the shudder while the lockup clutch 9 slips can desirably be reduced.

As described above, the hydraulic power transmission 1 in the embodiment constitutes the dynamic damper which is configured to absorb the oscillations transmitted to the input-side centerpiece 2 from the input element 81 of the damper mechanism 8 by at least the turbine runner 5 and the third coil springs 86 as the second resilient member which engages both the turbine runner 5 and the input element 81 of the damper mechanism 8 when the input-side centerpiece 2 as the input member and the input element 81 of the damper mechanism 8 are engaged by the lockup clutch 9. Accordingly, in the hydraulic power transmission 1, the oscillations are absorbed by the aforementioned dynamic damper on the more upstream side of the power transmitting route from the input-side centerpiece 2 to the variable speed gear as the object of power transmission, so that the oscillations transmitted from the side of the engine as the prime mover to the hydraulic power transmission 1, that is, to the input-side centerpiece 2 is absorbed (damped) effectively by the aforementioned dynamic damper before being damped by the elements on the downstream side of the input element 81 of the damper mechanism 8 so that the probability of transmission of the oscillations to the downstream side of the input element 81 can desirably be reduced.

Also, if the output element 82 of the damper mechanism 8 is coupled to the variable speed gear as the object of power transmission from the prime mover via the damper hub 7 as in the aforementioned embodiment, by configuring the dynamic damper with at least the turbine runner 5 and the third coil springs 86, the turbine runner 5 which does not contribute to the transmission of the power in a range from the input-side centerpiece 2 to the variable speed gear when the input-side centerpiece 2 and the input element 81 of the damper mechanism 8 are engaged by the lockup clutch 9 can be used as the mass of the dynamic damper, so that the oscillations transmitted from the side of the engine as the prime mover to the input-side centerpiece 2 can be effectively damped with the dynamic damper. Then, by adding the weight Mt as the mass body to the turbine runner 5 as in the aforementioned embodiment, the oscillation damping characteristics of the dynamic damper including the turbine runner 5 and the third coil springs 86 can be set easily and flexibly.

Furthermore, in the hydraulic power transmission 1 in the embodiment, the friction generating mechanism 89 which is capable of applying a friction according to the oscillations transmitted from the input element 81 to the turbine runner 5 to the input element 81 when the input-side centerpiece 2 and the input element 81 of the damper mechanism 8 are engaged by the lockup clutch 9 and the number of revolutions of the input-side centerpiece 2 is included in a predetermined resonant revolution range in advance is arranged between the input element 81 of the damper mechanism 8 and the turbine runner 5. Accordingly, the friction according to the oscillations transmitted from the input element 81 to the turbine runner 5 is applied from the friction generating mechanism 89 to the input element 81 when the number of revolutions of the input-side centerpiece 2 is included in the resonant revolution range to desirably damp the resonance generated in association with the utilization of the dynamic damper and desirably reduce the probability of transmission of the oscillations to the downstream side of the input element 81.

Also, the friction generating mechanism 89 in the embodiment is arranged between the input element 81 (the third input plate 813) of the damper mechanism 8 and the turbine runner 5 (the turbine coupling member 87) so as to be pivotable about the axis, and includes the annular member 890 to be engaged with the turbine runner 5 (the turbine coupling member 87) with a play and the friction member 891 fixed to the annular member 890 so as to come into contact with the input element 81. According to the friction generating mechanism 89 as described above, when the play between the turbine coupling member 87 (the axial projections 872) and the annular member 890 (the radial projections 890a) is reduced by the oscillations of the turbine runner 5 which is engaged with the input element 81 via the third coil springs 86 and hence the both come into abutment with each other, the annular member 890 is moved (rotated) with respect to the input element 81 by the turbine runner 5 and hence is fixed to the annular member 890, and the friction according to the oscillations can be applied from the friction member 891 which comes into contact with the input element 81 to the input element 81.

Furthermore, in the hydraulic power transmission 1 in the embodiment, the weight Mi as the mass body is added to the input element 81 of the damper mechanism 8, and the weight of the weight Mi is determined so that the resonance frequency of the system including the input element 81, the weight Mi, and the first coil springs 83 matches the resonance frequency of the aforementioned dynamic damper, that is, the system including the turbine runner 5, the turbine coupling member 87, the weight Mt, and the third coil springs 86. Accordingly, the oscillations transmitted from the engine side to the hydraulic power transmission 1, that is, to the input-side centerpiece 2 are damped by the dynamic damper including the turbine runner 5, the turbine coupling member 87, the weight Mt and the third coil springs 86, and the probability of the occurrence of so-called the shudder is desirably reduced when the lockup clutch 9 slips at the time of the slip control or the like.

When the input element 81 of the damper mechanism 8 includes a plurality of members as the hydraulic power transmission 1 in the embodiment, the third coil springs 86 which constitute the dynamic damper can be engaged with any one of the plurality of members which constitute the input element 81. Also, the hydraulic power transmission 1 may be configured in such a manner that the turbine runner 5 is connected to the input shaft of the variable speed gear via the turbine hub or the like. Furthermore, although the above-described hydraulic power transmission 1 is configured as the torque converter having a torque amplification function having the stator 6 which rectifies the flow of the hydraulic fluid from the turbine runner 5 to the pump impeller 4, the hydraulic power transmission in the present invention may be configured as a fluid joint which does not have the stator 6, that is, the torque amplification function.

Here, the relationship of correspondence between the principal elements in the embodiment and the principal elements of the present invention descried in the section of Disclosure of the Invention will be described. In other words, in the aforementioned embodiment, the hydraulic power transmission 1 including the pump impeller 4 connected to the input-side centerpiece 2 as the input member to be connected to the engine as the prime mover, the turbine runner 5 rotatable coaxially with the pump impeller 4, the damper mechanism 8 having the input element 81, the first coil springs 83 as the resilient members which engage the input element 81, and the output element 82, and the lockup clutch 9 which is capable of engaging the input-side centerpiece 2 and the input element 81 of the damper mechanism 8 and releasing the engagement therebetween corresponds to “hydraulic power transmission”, and the dynamic damper including the turbine runner 5 configured to absorb the oscillations transmitted to the input-side centerpiece 2 from the input element 81 and the third coil springs 86 as the second resilient member when the input-side centerpiece 2 and the input element 81 of the damper mechanism 8 are engaged by the lockup clutch 9 corresponds to “dynamic damper”.

However, since the relationship of correspondence between the principal elements in the embodiment and the principal elements in the invention described in the section of Disclosure of the Invention are examples for explaining the mode for carrying out the invention whose embodiments are described in the Disclosure of the Invention in detail, it does not limit the elements in the invention described in the section of Disclosure of the Invention. In other words, the embodiment is only the detailed example of the invention descried in the section of Disclosure of the Invention, and the interpretation of the invention described in the section of Disclosure of the Invention is to be done on the basis of the description in the corresponding section.

Although the mode of carrying out the present invention has been described thus far using the embodiment, the present invention is not limited to the embodiment described above, and may be modified variously without departing the scope of the present invention as a matter of course.

The present invention is applicable in the field of manufacturing the hydraulic power transmission and so on.

What is claimed is:

1. A hydraulic power transmission including a pump impeller connected to an input member coupled to a prime mover, a turbine runner rotatable coaxially with the pump impeller, a damper mechanism having an input element, a resilient member engaged with the input element, and an output element, and a lockup clutch configured to be capable of engaging the input member and the input element of the damper mechanism and releasing the engagement therebetween, comprising:
a dynamic damper configured in such a manner that oscillations transmitted to the input member when the input member and the input element of the damper mechanism are engaged by the lockup clutch is absorbed from the input element.

2. The hydraulic power transmission according to claim 1, wherein the output element of the damper mechanism is coupled to an object of power transmission from the prime mover, and the dynamic damper includes at least the turbine runner and a second resilient member engaging both the turbine runner and the input element of the damper mechanism.

3. The hydraulic power transmission according to claim 2, further comprising a mass body added to the turbine runner.

4. The hydraulic power transmission according to claim 2, further comprising a friction generating mechanism arranged between the input element of the damper mechanism and the turbine runner and configured to be capable of applying a friction according to the oscillations transmitted from the input element to the turbine runner to the input element when the input member and the input element of the damper mechanism are engaged by the lockup clutch and the number of revolutions of the input member is included in a predetermined revolution range in advance.

5. The hydraulic power transmission according to claim 4, wherein the friction generating mechanism includes an annular member arranged between the input element of the damper mechanism and the turbine runner so as to be pivotable about an axis and engaging the turbine runner with a play, and a friction member fixed to the annular member so as to come into contact with the input element.

6. The hydraulic power transmission according to claim 5, further comprising a mass body added to the input element of the damper mechanism and wherein the weight of the mass body is fixed so that the resonance frequency of a system including the input element, the mass body, and the resilient member engaging the input element matches the resonance frequency of the dynamic damper.

7. The hydraulic power transmission according to claim 1, further comprising a mass body added to the input element of the damper mechanism and wherein the weight of the mass body is fixed so that the resonance frequency of a system including the input element, the mass body, and the resilient member engaging the input element matches the resonance frequency of the dynamic damper.
